(19) United States
(12) Patent Application Publication
(10) Pub. No.: US 2015/0029742 A1
(43) Pub. Date: Jan. 29, 2015

(54) LIGHT GUIDE TUBE AND LIGHT EMITTING DIODE TUBE LAMP INCORPORATING THE SAME

(71) Applicant: HON HAI PRECISION INDUSTRY CO., LTD., New Taipei (TW)

(72) Inventor: Po-Chou CHEN, Tu-Cheng (TW)

(73) Assignee: HON HAI PRECISION INDUSTRY CO., LTD., New Taipei (TW)

(21) Appl. No.: 14/067,970

(22) Filed: Oct. 31, 2013

(30) Foreign Application Priority Data
Jul. 29, 2013 (TW) 102127063

(51) Int. Cl. F21K 99/00

(52) U.S. Cl. CPC F21K 9/52
USPC 362/555

(57) ABSTRACT

A light guide tube includes an inner wall, an outer wall surrounding and spaced from the inner wall and an optical waveguide layer located between the inner wall and the outer wall. The inner wall and/or the outer wall of the light guide tube define/defines a plurality of light extraction dots therein for extracting light generated by LEDs located at two opposite ends of the light guide tube and emitted into the optical waveguide layer out of the light guide tube from a circumferential periphery thereof. A light emitting diode tube lamp incorporating the light guide tube is also provided.

### TECHNICAL FIELD

The present disclosure generally relates to a light guide tube and a light emitting diode tube lamp incorporating the light guide tube, wherein the light emitting diode tube lamp has a wide light distribution angle.

### DESCRIPTION OF RELATED ART

The fluorescent lamp includes a glass tube coated on the inside thereof with phosphor powders which emit visible light when excited by ultraviolet light. The glass tube has low-pressured mercury vapor therein. Electrodes are mounted at two ends of the glass tubes, which emit electrons during operation of the fluorescent lamp.

The electrons are accelerated by voltage across tube until they collide with mercury atoms, causing the mercury atoms to be ionized and excited. When the mercury atoms return to their normal state, photons corresponding to mercury spectral lines in both the visible and ultraviolet region are generated, thereby exciting the phosphor coating on the inside of the tube to cause the phosphor to radiate. However, the fluorescent lamp is prohibited due to mercury pollution to the environment.

LEDs are solid state light emitting devices formed of semiconductors, which are more stable and reliable than other conventional light sources such as fluorescent lamp. However, light emitted from the LED light source is generally limited within a conical region near an optical axis thereof. Therefore, such an LED light source is difficult to satisfy the requirements of wide light distribution angle.

What is needed therefore is a light guide tube and a light emitting diode tube lamp incorporating the light guide tube which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is an assembled, perspective view of a light emitting diode (LED) tube lamp in accordance with a first embodiment of the present disclosure.

FIG. 2 is an exploded view of the LED tube lamp of FIG. 1.

FIG. 3 is a cross-sectional view of the LED tube lamp of FIG. 1, taken along a line III-III thereof.

FIG. 4 is a right-side, elevational view of the LED tube lamp of FIG. 1.

FIG. 5 is a schematic, cross-sectional view of a light emitting diode (LED) tube lamp in accordance with a second embodiment of the present disclosure.

### DETAILED DESCRIPTION

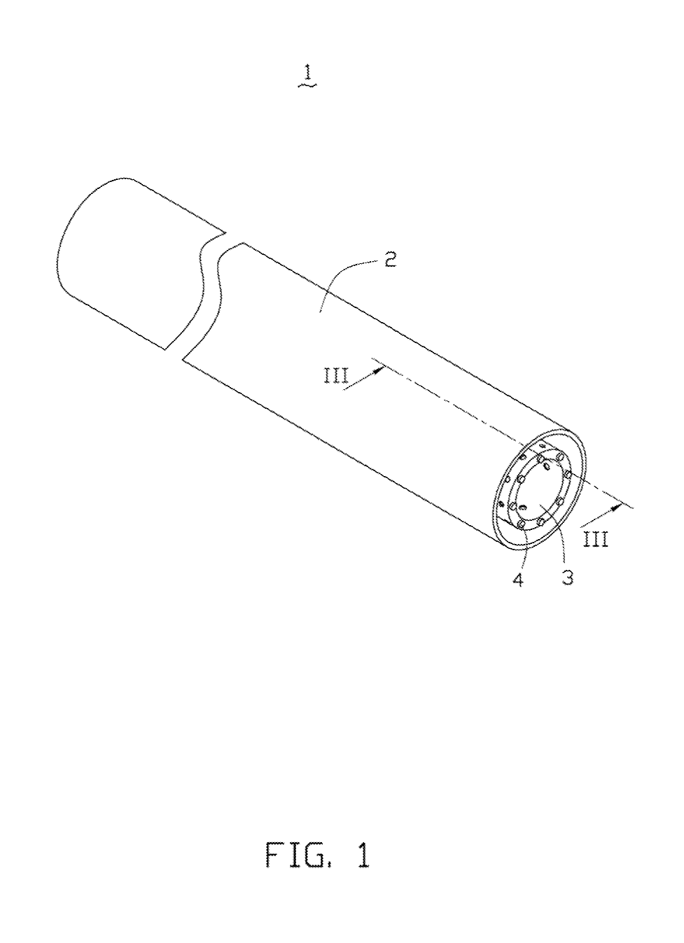

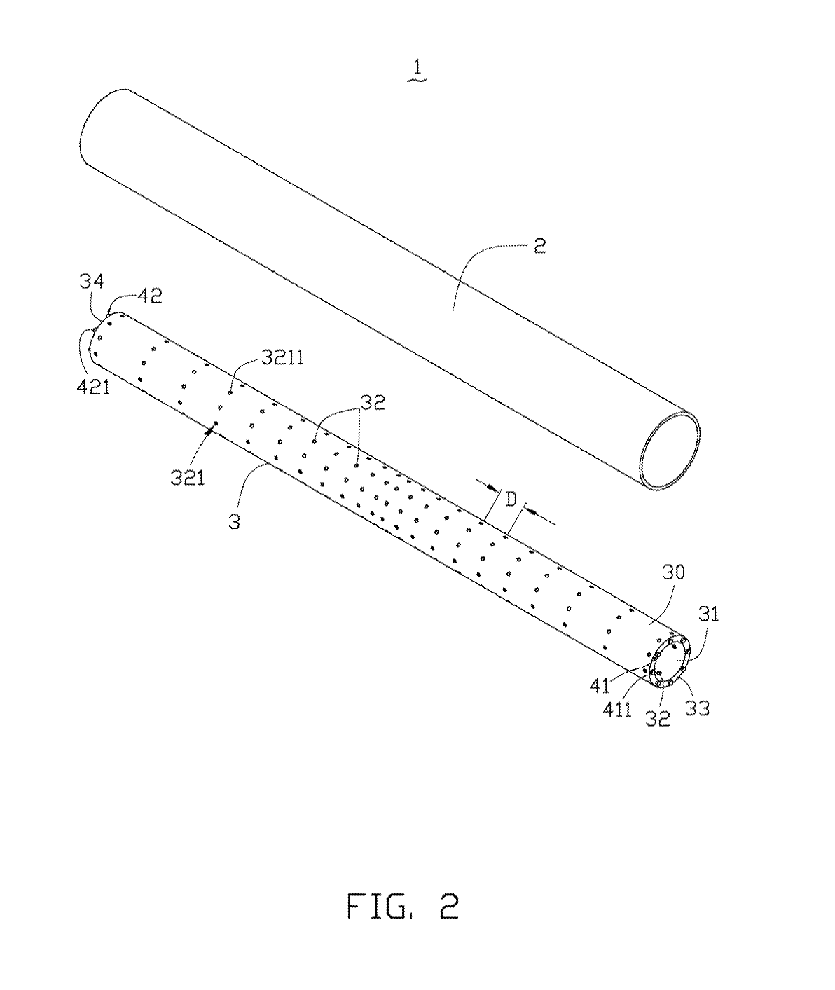

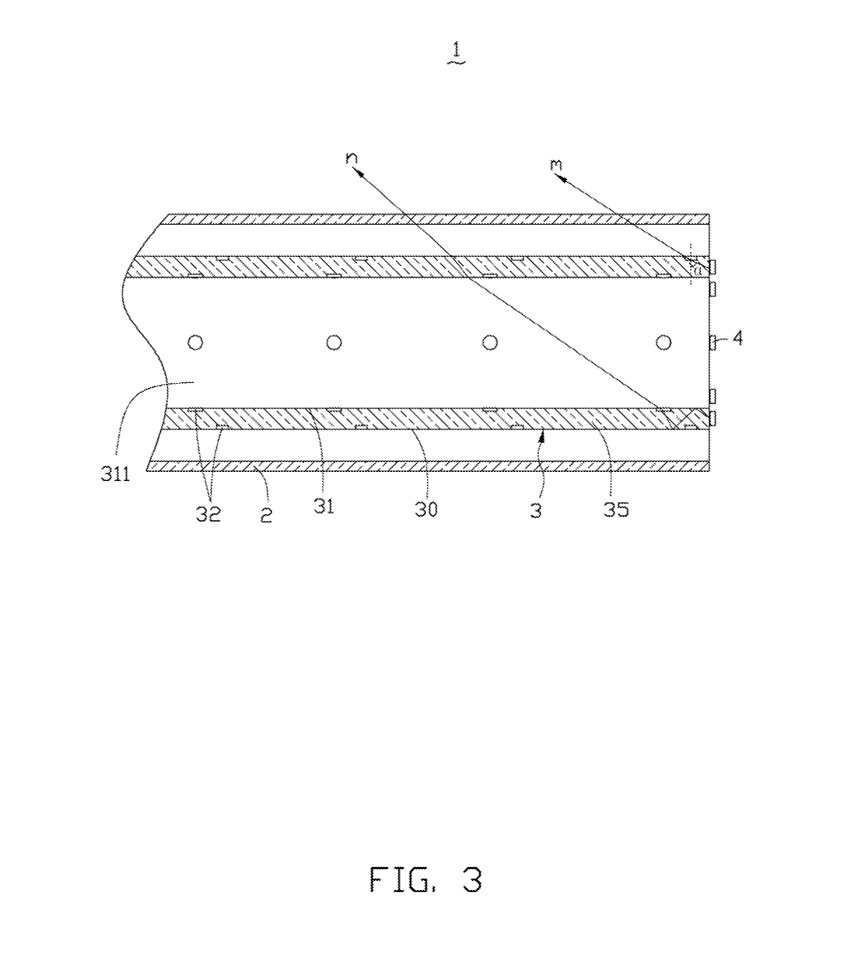

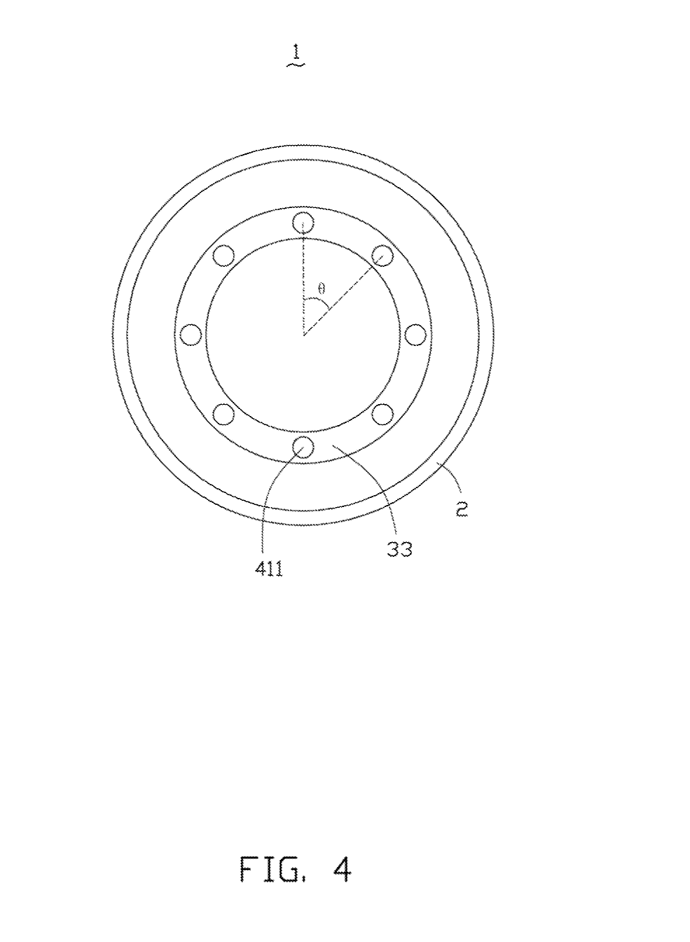

Referring to FIGS. 1 through 4, a light emitting diode (LED) tube lamp 1 in accordance with a first embodiment of the present disclosure includes a light guide tube 3, a plurality of LED light sources 4 respectively located at two opposite ends 33, 34 of the light guide tube 3, and a light diffuser tube 2. The light guide tube 3 is sleeved into the light diffuser tube 2.

The light guide tube 3 includes an inner wall 31, an outer wall 30 surrounding and spaced from the inner wall 31, and an optical waveguide layer 35 located between the outer wall 30 and the inner wall 31. The inner wall 31 and the outer wall 30 of the light guide tube 3 both define a plurality of light extraction dots 32 therein for extracting light from the optical waveguide layer 35.

The light extraction dots 32 include a series of circumferential rows 321, with each row 321 arranged in a line along a circumferential direction of the light guide tube 3. Each circumferential row 321 includes a plurality of spaced light extraction dots 3211 evenly distributed therein. In more details, the light extraction dots 3211 arranged in a circumferential row 321 are equidistantly spaced from each other at a predetermined interval (angle).

A distance D defined between every two adjacent circumferential rows 321 firstly decreases gradually and then increases gradually along a longitudinal direction of the light guide tube 3 from one of two opposite ends 33, 34 toward the other end thereof. Accordingly, a middle section of the light guide tube 3 has more light extraction dots 3211 than each of the two opposite end sections of the light guide tube 3.

The two opposite ends 33, 34 of the light guide tube 3 each are annular. The LED light sources 4 include a first group of light sources 41 and a second group of light sources 42 spaced from the first group of light sources 41. The first group of light sources 41 is positioned on the annular end 33 of the light guide tube 3. The second group of light sources 42 is positioned on the annular end 34 of the light guide tube 3 opposite to the annular end 33.

The first group of light sources 41 includes a plurality of LED light sources 411 arranged in a circle on the annular end 33 of the light guide tube 3. The LED light sources 411 are equidistantly spaced from each other at a predetermined angle of 45 degrees. In more details, the first group of light sources 41 includes eight LED light sources 411 arranged in a circle on the annular end 33, and an angle θ defined between a line connecting a center of the annular end 33 to an LED light source 411 and another line connecting a center of the annular end 33 to an adjacent LED light source 411 is 45 degrees.

The second group of light sources 42 includes a plurality of LED light sources 421 arranged in a circle on the annular end 34 of the light guide tube 3. The LED light sources 421 are equidistantly spaced from each other at a predetermined angle of 45 degrees. In the present embodiment, the first group of light sources 41 and the second group of light sources 42 are symmetrically positioned on the two opposite ends 33, 34 of the light guide tube 3.

It is to be understood that the LED light sources 4 could be positioned at only one of two opposite ends 33, 34, such as the annular end 33 of the light guide tube 3. In such a case, a distance between two adjacent circumferential rows 321 decreases gradually along a longitudinal direction of the light guide tube 3 from the end 33 toward the other end 34 thereof. Accordingly, the density of the light extraction dots 3211 increases gradually along a longitudinal direction of the light guide tube 3 from the end 33 toward the other end 34 thereof.

The diffuser tube 2 is a hollow tube with an inner diameter larger than an outer diameter of the light guide tube 3. The light guide tube 3 is completely inserted into the light diffuser tube 2 and surrounded by the inner wall of the diffuser tube 2. The diffuser tube 2 is made of transparent or translucent material such as glass or polycarbonate, for transmission of the light extracted from the optical waveguide layer 35 of the light guide tube 3 therethrough. It is preferred that an inner wall 31 and/or an outer wall 30 of the diffuser tube 2 are/is frosted so as to evenly diffuse the light.

In the present embodiment, light emitted from the LED light sources 4 is refracted into the optical waveguide layer 35 of the light guide tube 3, and a portion of light having an angle of incidence larger than a critical angle a of total internal reflection is extracted out of the optical waveguide layer 35 through the light extraction dots 32 distributed in the inner wall 31 and/or the outer wall 30 of the light guide tube 3. That is to say, the LED tube lamp 1 irradiates light out of the light guide tube 3 along different directions around a total circumferential periphery of the light guide tube 3, thereby to form an omnidirectional light distribution or radiation in the space perpendicular to the optical axis of each LED light source 4; thus the LED tube lamp 1 having a wide light distribution angle is obtained.

In use, when a light ray m hits the light extraction dots 32 distributed in the outer wall 30 of the light guide tube 3, the light ray m is extracted from the optical waveguide layer 35 along an inclined direction away from the outer wall 32 toward the other end 34 of the light guide tube 3 due to a change of the angle of radiation at the optical waveguide layer-air interface, and then the light ray m passes through the diffuser tube 2 into ambient air. When a light ray n hits the light extraction dots 32 distributed in the inner wall 31 of the light guide tube 3, then the light ray n is refracted from the optical waveguide layer 35 into a cavity 311 surrounded by the inner wall 31 along an inclined direction away from the inner wall 31 toward the other end 34 of the light guide tube 3 due to a change of the angle of radiation at the optical waveguide layer-air interface, and finally the light ray n passes through the cavity 311, the waveguide layer 35 and the diffuser tube 2 into ambient air. In the present embodiment, the light extraction dots 32 are rectangular micro-cavities, and a size of each light extraction dot 32 is in the range of ten to one hundred microns. Alternatively, the light extraction dots 32 each are a V-shaped groove in a micron scale size.

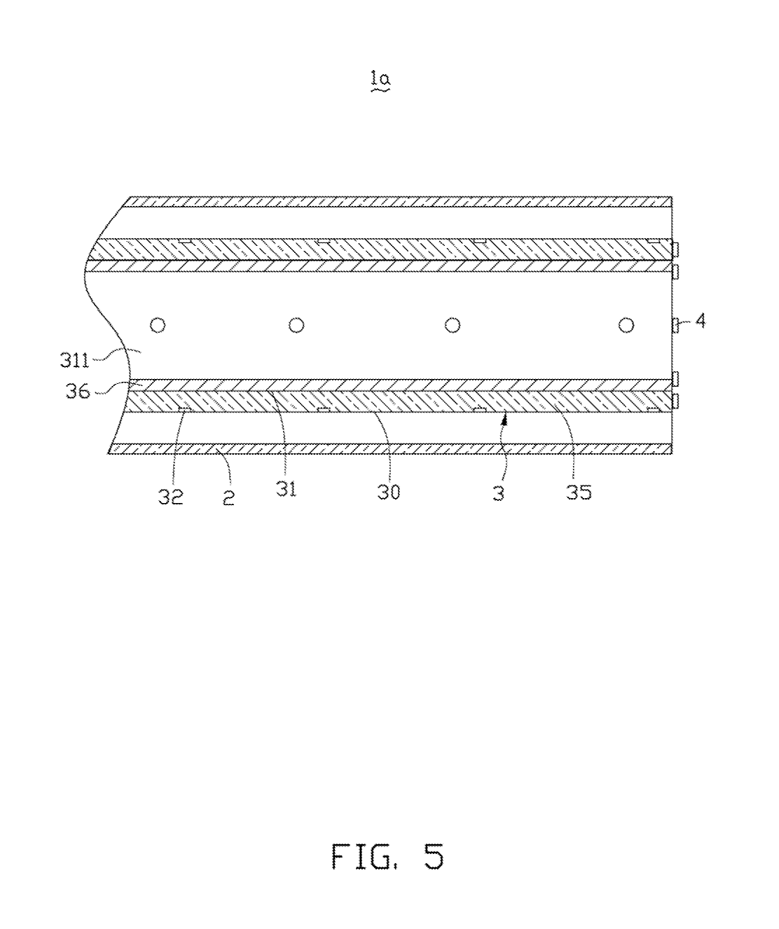

Referring to FIG. 5, an LED tube lamp 1 a in accordance with a second embodiment of the present disclosure is illustrated. Different from the LED tube lamp 1 shown in FIG. 1, the light extraction dots 32 of the LED tube lamp 1a are only distributed in the outer wall 30 of the light guide tube 3. The light extraction dots 32 are evenly distributed in the outer wall 30 along a longitudinal direction of the light guide tube 3. A reflective layer 36 covers an inner wall 31 of the light guide tube 3 for reflecting light leaking from the optical waveguide layer 35 back toward the optical waveguide layer 35, thereby improving the light utilization efficiency of the LED tube lamp 1a. Alternatively, the light extraction dots 32 could be randomly distributed in the outer wall 30 of the light guide tube 3 so as to evenly diffuse light.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An elongated light guide tube for guiding light of light emitting diodes (LEDs) located at least at one of two opposite ends of the light guide tube to radiate out of the light guide tube from a circumferential periphery thereof, comprising:
an inner wall;
an outer wall surrounding and spaced from the inner wall, the outer wall defining the circumferential periphery of the light guide tube; and
an optical waveguide layer located between the inner wall and the outer wall;
wherein the inner wall and/or the outer wall of the light guide tube define/defines a plurality of light extraction dots therein, configured for extracting the light emitted into the optical waveguide layer from the LEDs out of the light guide tube from the circumferential periphery thereof.

2. The light guide tube of claim 1, wherein the light extraction dots comprise a series of circumferential rows arranged in a circumferential direction of the light guide tube.

3. The light guide tube of claim 2, wherein each circumferential row comprises a plurality of spaced light extraction dots evenly distributed therein.

4. The light guide tube of claim 3, the light extraction dots are evenly distributed in the inner wall and/or the outer wall of the light guide tube along a longitudinal direction of the light guide tube from one of the two opposite ends toward the other end thereof.

5. The light guide tube of claim 3, wherein a distance between two adjacent circumferential rows firstly decreases gradually and then increases gradually along a longitudinal direction of the light guide tube from one of the two opposite ends toward the other end thereof.

6. The light guide tube of claim 5, wherein a middle section of the light guide tube has more light extraction dots than each of two opposite end sections thereof.

7. The light guide tube of claim 3, wherein a distance between every two adjacent circumferential rows firstly decreases gradually along a longitudinal direction of the light guide tube from one of the two opposite ends toward the other end thereof.

8. A light emitting diode (LED) tube lamp, comprising:
a light guide tube; and
a plurality of LED light sources located at least at one of two opposite ends of the light guide tube;
wherein the light guide tube comprises an inner wall, an outer wall surrounding and spaced from the inner wall and defining a circumferential periphery of the light guide tube, and an optical waveguide layer located between the inner wall and the outer wall; and
wherein the inner wall and/or the outer wall of the light guide tube define/defines a plurality of light extraction dots therein for extracting light emitted into the optical waveguide layer from the LED light sources out of the light guide tube via an entirety of the circumferential periphery of the light guide tube.

9. The LED tube lamp of claim 8, wherein the light extraction dots are randomly distributed in the inner wall and/or the outer wall of the light guide tube.

10. The LED tube lamp of claim 8, wherein the light extraction dots comprises a series of circumferential rows arranged in a circumferential direction of the light guide tube.

11. The LED tube lamp of claim 10, wherein each circumferential row comprises a plurality of spaced light extraction dots evenly distributed therein.

12. The LED tube lamp of claim 10, wherein the light extraction dots are evenly distributed in the inner wall and/or the outer wall of the light guide tube along a longitudinal direction thereof.

13. The LED tube lamp of claim 11, wherein the LED light sources are located at one end of the light guide tube, and a distance between every two adjacent circumferential rows decreases along a longitudinal direction of the light guide tube away from the LED light sources.

14. The LED tube lamp of claim 13, wherein a density of the light extraction dots increases along a longitudinal direction of the light guide tube away from the LED light sources.

15. The LED tube lamp of claim 11, wherein the LED light sources are located at the two opposite ends of the light guide tube, and a distance between every two adjacent circumferential rows firstly decreases gradually and then increases gradually along a longitudinal direction of the light guide tube from one of two opposite ends toward the other end thereof.

16. The LED tube lamp of claim 15, wherein a middle section of the light guide tube has more light extraction dots than each of two opposite end sections of the light guide tube.

17. The LED tube lamp of claim 8, wherein the light extraction dots are only distributed in the outer wall of the light guide tube, and a reflective layer covers the inner wall of the light guide tube for reflecting light leaking from the optical waveguide layer back toward the optical waveguide layer.

18. The LED tube lamp of claim 8, further comprising a light diffuser tube with an inner diameter larger than the outer diameter of the light guide tube, and the light guide tube is completely inserted into the light diffuser tube.

19. The LED tube lamp of claim 8, wherein the light extraction dots are micro-cavities.

20. The LED tube lamp of claim 8, wherein the LED light sources comprises a first group of light sources and a second group of light sources spaced from the first group of light sources, the first group of light sources is positioned on one annular end of the light guide tube in a circle, and the second group of light sources is positioned on the other annular end of the light guide tube in a circle.
